(19) United States
(12) Patent Application Publication
(10) Pub. No.: US 2026/0067853 A1
(43) Pub. Date: Mar. 5, 2026

(54) METHOD FOR COMMUNICATION, TERMINAL DEVICE, AND NETWORK DEVICE

(71) Applicant: QUECTEL WIRELESS SOLUTIONS CO., LTD., Shanghai (CN)

(72) Inventors: Zheng ZHAO, Shanghai (CN); Ling LYU, Shanghai (CN); Zhongzhi YANG, Shanghai (CN)

(21) Appl. No.: 19/379,850

(22) Filed: Nov. 5, 2025

Related U.S. Application Data
(63) Continuation of application No. PCT/CN2023/092327, filed on May 5, 2023.

(51) Int. Cl. H04W 64/00; H04W 48/16

(52) U.S. Cl. CPC H04W 64/00; H04W 48/16

(57) ABSTRACT

A method for communication, a terminal device, and a network device are provided. One example method includes: receiving, by a terminal device, first information, wherein the first information indicates information of a first network device, and the first information is related to positioning of the terminal device.

### CROSS-REFERENCE TO RELATED APPLICATIONS

This application is a continuation of International Application No. PCT/CN2023/092327, filed on May 5, 2023, the disclosure of which is hereby incorporated by reference in its entirety.

### TECHNICAL FIELD

The present disclosure relates to the field of communication technology, and more specifically to a method for communication, a terminal device, and a network device.

### BACKGROUND

Some wireless communication systems may include servers. The characteristics of the server may include high computing power, large storage capacity, and extremely high throughput efficiency. Consequently, the server can simultaneously execute tasks such as massive data computation and can also implement algorithms of high complexity. Therefore, in relevant technologies, the solution of position coordinates of a terminal device may be performed on the server. Such a server is also referred to as a location server.

The location server may achieve positioning of the terminal device based on collected positioning data. In some cases, the volume of positioning data may be substantial. For example, when a large number of terminal devices connect to a communication network, massive amounts of positioning data may be generated. If the volume of positioning data exceeds an upper limit of a data threshold that the location server can process, it may result in data congestion.

### SUMMARY

The present disclosure provides a method for communication, a terminal device, and a network device. Various aspects related to the present disclosure are described below.

According to a first aspect, a method for communication is provided, including: receiving, by a terminal device, first information; where the first information is used to indicate information of a first network device, and the first information is related to positioning of the terminal device.

In some embodiments, the information of the first network device includes one or more of: an identity of the first network device; an identity of a cell corresponding to the first network device; and position information of the first network device.

In some embodiments, the method further includes: executing, by the terminal device, a first operation based on the first information to obtain second information; where the first operation is related to a position solution of the terminal device.

In some embodiments, the second information includes one or both of: an estimated distance between the terminal device and the first network device; and a first position solution result of the terminal device.

In some embodiments, the method further includes: sending, by the terminal device, the second information; where the second information is used to determine a second position solution result of the terminal device.

In some embodiments, the first network device is located in a first region, the first region includes a plurality of network devices, the plurality of network devices include a master network device, and the second information is related to a position of the master network device.

In some embodiments, the second information includes the first position solution result of the terminal device, and the first position solution result is determined based on a Lagrange operator product algorithm and the position of the master network device.

In some embodiments, the plurality of network devices include a second network device, the second network device is the master network device when a first condition is met, and the first condition is related to one or both of: a quality of a signal transmitted by the second network device; and a position relationship between the second network device and the terminal device.

In some embodiments, the first condition includes: a distance between the second network device and the terminal device is minimum in the plurality of network devices; and/or, the quality of the signal transmitted by the second network device is best in the plurality of network devices.

In some embodiments, the plurality of network devices further include m neighbor network devices, m is a positive integer, and one or both of the master network device and the m neighbor network devices are configured to position the terminal device when a second condition is met; and where the second condition is related to one or more of following information of one or both of the master network device and the m neighbor network devices: a quality of a transmitted signal; a position relationship with the terminal device; and horizontal dilution of precision (HDOP).

In some embodiments, the HDOP satisfies:

$$H = [ \begin{matrix}\frac{\hat{x} - {x}_{0}}{{\hat{d}}_{0}} & \frac{\hat{y} - {y}_{0}}{{\hat{d}}_{0}} \\ ⋮ & ⋮ \\ \frac{\hat{x} - {x}_{m}}{{\hat{d}}_{m}} & \frac{\hat{y} - {y}_{m}}{{\hat{d}}_{m}}\end{matrix} ] , G = {( {H}^{T} H )}^{- 1} , HDOP = {G}_{11} + {G}_{22} ;$$

where (x₀, y₀) are position coordinates of the master network device, (x₁, y₁) to (xₘ, yₘ) are coordinates of a first neighbor network device to an m^{th} neighbor network device, respectively, (\hat{x}, ŷ) are coordinates of the terminal device, do is a distance between the terminal device and the master network device, \hat{d}₁ to d̅ₘ are distances between the terminal device and the first neighbor network device to the m^{th} neighbor network device, respectively, and G₁₁ and G₂₂ are diagonal elements of G.

In some embodiments, the second condition includes that coverage areas of the master network device and the m neighbor network devices are all able to cover the terminal device.

According to a second aspect, a method for communication is provided, including: sending, by a first network device, first information to a terminal device; where the first information is used to indicate information of the first network device, and the first information is related to positioning of the terminal device.

In some embodiments, the information of the first network device includes one or more of: an identity of the first network device; an identity of a cell corresponding to the first network device; and position information of the first network device.

In some embodiments, the method further includes: receiving, by the first network device, second information sent by the terminal device; where the second information is obtained based on the first information and a first operation, and the first operation is related to a position solution of the terminal device.

In some embodiments, the second information includes one or both of: an estimated distance between the terminal device and the first network device; and a first position solution result of the terminal device.

In some embodiments, the method further includes: determining, by the first network device, a second position solution result of the terminal device according to the second information.

In some embodiments, the first network device is located in a first region, the first region includes a plurality of network devices, the plurality of network devices include a master network device, and the second information is related to a position of the master network device.

In some embodiments, the second information includes the first position solution result of the terminal device, and the first position solution result is determined based on a Lagrange operator product algorithm and the position of the master network device.

In some embodiments, the plurality of network devices include a second network device, the second network device is the master network device when a first condition is met, and the first condition is related to one or both of: a quality of a signal transmitted by the second network device; and a position relationship between the second network device and the terminal device.

In some embodiments, the first condition includes: a distance between the second network device and the terminal device is minimum in the plurality of network devices; and/or, the quality of the signal transmitted by the second network device is best in the plurality of network devices.

In some embodiments, the plurality of network devices further include m neighbor network devices, m is a positive integer, and one or both of the master network device and the m neighbor network devices are configured to position the terminal device when a second condition is met; and where the second condition is related to one or more of following information of one or both of the master network device and the m neighbor network devices: a quality of a transmitted signal; a position relationship with the terminal device; and horizontal dilution of precision (HDOP).

In some embodiments, the HDOP satisfies:

$$H = [ \begin{matrix}\frac{\hat{x} - {x}_{0}}{{\hat{d}}_{0}} & \frac{\hat{y} - {y}_{0}}{{\hat{d}}_{0}} \\ ⋮ & ⋮ \\ \frac{\hat{x} - {x}_{m}}{{\hat{d}}_{m}} & \frac{\hat{y} - {y}_{m}}{{\hat{d}}_{m}}\end{matrix} ] , G = {( {H}^{T} H )}^{- 1} , HDOP = {G}_{11} + {G}_{22} ;$$

where (x₀, y₀) are position coordinates of the master network device, (x₁, y₁) to (xₘ, yₘ) are coordinates of a first neighbor network device to an m^{th} neighbor network device, respectively, (\hat{x}, ŷ) are coordinates of the terminal device, \hat{d}₀ is a distance between the terminal device and the master network device, \hat{d}₁ to \hat{d}ₘ are distances between the terminal device and the first neighbor network device to the m^{th} neighbor network device, respectively, and G₁₁ and G₂₂ are diagonal elements of G.

In some embodiments, the second condition includes that coverage areas of the master network device and the m neighbor network devices are all able to cover the terminal device.

According to a third aspect, a terminal device is provided, including: a first receiving unit, configured to receive first information; where the first information is used to indicate information of a first network device, and the first information is related to positioning of the terminal device.

In some embodiments, the information of the first network device includes one or more of: an identity of the first network device; an identity of a cell corresponding to the first network device; and position information of the first network device.

In some embodiments, the terminal device further includes: an execution unit, configured to execute a first operation based on the first information to obtain second information; where the first operation is related to a position solution of the terminal device.

In some embodiments, the second information includes one or both of: an estimated distance between the terminal device and the first network device; and a first position solution result of the terminal device.

In some embodiments, the terminal device further includes: a first sending unit, configured to send the second information; where the second information is used to determine a second position solution result of the terminal device.

In some embodiments, the first network device is located in a first region, the first region includes a plurality of network devices, the plurality of network devices include a master network device, and the second information is related to a position of the master network device.

In some embodiments, the second information includes the first position solution result of the terminal device, and the first position solution result is determined based on a Lagrange operator product algorithm and the position of the master network device.

In some embodiments, the plurality of network devices include a second network device, the second network device is the master network device when a first condition is met, and the first condition is related to one or both of: a quality of a signal transmitted by the second network device; and a position relationship between the second network device and the terminal device.

In some embodiments, the first condition includes: a distance between the second network device and the terminal device is minimum in the plurality of network devices; and/or, the quality of the signal transmitted by the second network device is best in the plurality of network devices.

In some embodiments, the plurality of network devices further include m neighbor network devices, m is a positive integer, and one or both of the master network device and the m neighbor network devices are configured to position the terminal device when a second condition is met; and where the second condition is related to one or both of following information of one or both of the master network device and the m neighbor network devices: a quality of a transmitted signal; a position relationship with the terminal device; and horizontal dilution of precision (HDOP).

In some embodiments, the HDOP satisfies:

$$H = [ \begin{matrix}\frac{\hat{x} - {x}_{0}}{{\hat{d}}_{0}} & \frac{\hat{y} - {y}_{0}}{{\hat{d}}_{0}} \\ ⋮ & ⋮ \\ \frac{\hat{x} - {x}_{m}}{{\hat{d}}_{m}} & \frac{\hat{y} - {y}_{m}}{{\hat{d}}_{m}}\end{matrix} ] , G = {( {H}^{T} H )}^{- 1} , HDOP = {G}_{11} + {G}_{22} ;$$

where (x₀, y₀) are position coordinates of the master network device, (x₁, y₁) to (xₘ, yₘ) are coordinates of a first neighbor network device to an m^{th} neighbor network device, respectively, (\hat{x}, ŷ) are coordinates of the terminal device, \hat{d}₀ is a distance between the terminal device and the master network device, \hat{d}₁ to \hat{d}ₘ are distances between the terminal device and the first neighbor network device to the m^{th} neighbor network device, respectively, and G₁₁ and G₂₂ are diagonal elements of G.

In some embodiments, the second condition includes that coverage areas of the master network device and the m neighbor network devices are all able to cover the terminal device.

According to a fourth aspect, a network device is provided, where the network device is a first network device, including: a second sending unit, configured to send first information to a terminal device; where the first information is used to indicate information of the first network device, and the first information is related to positioning of the terminal device.

In some embodiments, the information of the first network device includes one or more of: an identity of the first network device; an identity of a cell corresponding to the first network device; and position information of the first network device.

In some embodiments, the network device further includes: a second receiving unit, configured to receive second information sent by the terminal device; where the second information is obtained based on the first information and a first operation, and the first operation is related to a position solution of the terminal device.

In some embodiments, the second information includes one or both of: an estimated distance between the terminal device and the first network device; and a first position solution result of the terminal device.

In some embodiments, the network device further includes: a determining unit, configured to determine a second position solution result of the terminal device according to the second information.

In some embodiments, the first network device is located in a first region, the first region includes a plurality of network devices, the plurality of network devices include a master network device, and the second information is related to a position of the master network device.

In some embodiments, the second information includes the first position solution result of the terminal device, and the first position solution result is determined based on a Lagrange operator product algorithm and the position of the master network device.

In some embodiments, the plurality of network devices include a second network device, the second network device is the master network device when a first condition is met, and the first condition is related to one or both of: a quality of a signal transmitted by the second network device; and a position relationship between the second network device and the terminal device.

In some embodiments, the first condition includes: a distance between the second network device and the terminal device is minimum in the plurality of network devices; and/or, the quality of the signal transmitted by the second network device is best in the plurality of network devices.

In some embodiments, the plurality of network devices further include m neighbor network devices, m is a positive integer, and one or both of the master network device and the m neighbor network devices are configured to position the terminal device when a second condition is met; and where the second condition is related to one or more of following information of one or both of the master network device and the m neighbor network devices: a quality of a transmitted signal; a position relationship with the terminal device; and horizontal dilution of precision (HDOP).

In some embodiments, the HDOP satisfies:

$$H = [ \begin{matrix}\frac{\hat{x} - {x}_{0}}{{\hat{d}}_{0}} & \frac{\hat{y} - {y}_{0}}{{\hat{d}}_{0}} \\ ⋮ & ⋮ \\ \frac{\hat{x} - {x}_{m}}{{\hat{d}}_{m}} & \frac{\hat{y} - {y}_{m}}{{\hat{d}}_{m}}\end{matrix} ] , G = {( {H}^{T} H )}^{- 1} , HDOP = {G}_{11} + {G}_{22} ;$$

where (x₀, y₀) are position coordinates of the master network device, (x₁, y₁) to (xₘ, yₘ) are coordinates of a first neighbor network device to an m^{th} neighbor network device, respectively, (\hat{x}, ŷ) are coordinates of the terminal device, \hat{d}₀ is a distance between the terminal device and the master network device, \hat{d}₁ to \hat{d}ₘ are distances between the terminal device and the first neighbor network device to the m^{th} neighbor network device, respectively, and G₁₁ and G₂₂ are diagonal elements of G.

In some embodiments, the second condition includes that coverage areas of the master network device and the m neighbor network devices are all able to cover the terminal device.

According to a fifth aspect, a terminal device is provided, including: a processor and a memory, where the memory is configured to store one or more computer programs, and the processor is configured to invoke the one or more computer programs in the memory to cause the terminal device to perform some or all of operations in the method according to the first aspect.

According to a sixth aspect, a network device is provided, including: a processor, a memory and a transceiver, where the memory is configured to store one or more programs, and the processor is configured to invoke the one or more programs in the memory to cause the network device to perform some or all of operations in the method according to the second aspect.

According to a seventh aspect, an embodiment of the present disclosure provides a communication system, where the system includes the terminal device and/or the network device described above. In another possible design, the system may further include another device in the solution provided in the embodiments of the present disclosure that interacts with the terminal device or the network device.

According to an eighth aspect, an embodiment of the present disclosure provides a computer-readable storage medium, where the computer-readable storage medium stores a computer program, and the computer program causes the terminal device and/or the network device to perform some or all of the operations in the methods in the foregoing aspects.

According to a ninth aspect, an embodiment of the present disclosure provides a computer program product, where the computer program product includes a non-transitory computer-readable storage medium storing a computer program, and the computer program is executable to cause the terminal device and/or the network device to perform some or all of the operations in the methods in the foregoing aspects. In some implementations, the computer program product may be a software installation package.

According to a tenth aspect, an embodiment of the present disclosure provides a chip, where the chip includes a memory and a processor, and the processor may invoke and run a computer program from the memory, to implement some or all of the operations described in the methods in the foregoing aspects.

For the terminal device, based on the information of the first network device, the terminal device participates in the positioning process of the terminal device, meaning that the terminal device participates in the position solution. In the case where the terminal device participates in the position solution, the terminal device is able to process part of the data, which alleviates the pressure on the location server, thereby enhancing robustness and sustainability of the system.

### BRIEF DESCRIPTION OF THE DRAWINGS

FIG. 1 is a schematic diagram of a wireless communication system applied in an embodiment of the present disclosure.

FIG. 2 is a schematic flowchart of a method for communication provided in an embodiment of the present disclosure.

FIG. 3 is an example diagram of a scenario applied in an embodiment of the present disclosure.

FIG. 4 is an example diagram of a geometry provided in an embodiment of the present disclosure.

FIG. 5 is another schematic flowchart of a method for communication provided in an embodiment of the present disclosure.

FIG. 6 is a schematic structural diagram of a terminal device provided in an embodiment of the present disclosure.

FIG. 7 is a schematic structural diagram of a network device provided in an embodiment of the present disclosure.

FIG. 8 is a schematic structural diagram of an apparatus for communication provided in an embodiment of the present disclosure.

### DETAILED DESCRIPTION OF THE EMBODIMENTS

The technical solutions in the present disclosure will be described below with reference to the accompanying drawings. For ease of understanding, terms involved in the present disclosure are described below.

### Communication System

FIG. 1 is a wireless communication system 100 applied in embodiments of the present disclosure. The wireless communication system 100 includes a network device 110 and a terminal device 120, and the network device 110 may be a device that communicates with the terminal device 120. The network device 110 provides communication coverage for a particular geographic area and communicates with the terminal device 120 located within the coverage area.

FIG. 1 exemplarily shows a network device and two terminals. Optionally, the wireless communication system 100 may include a plurality of network devices, and the coverage of each network device may include other numbers of terminals, which is not limited in the embodiments of the present disclosure.

Optionally, the wireless communication system 100 may further include another network entity such as a network controller, a mobility management entity, etc., which is not limited in the embodiments of the present disclosure.

It should be understood that the technical solutions in the embodiments of the present disclosure may be applied to various communication systems, for example, a 5th generation (5G) or new radio (NR) system, a 5G advanced system, a long term evolution (LTE) system, an LTE frequency division duplex (FDD) system, an LTE time division duplex (TDD) system, and the like. The technical solutions provided in the present disclosure may further be applied to a future communication system such as a sixth-generation mobile communication system, a satellite communication system, or the like.

The terminal device in the embodiments of the present disclosure may also be referred to as user equipment (UE), an access terminal, a subscriber unit, a subscriber station, a mobile station (MS), a mobile terminal (MT), a remote station, a remote terminal, a mobile device, a user terminal, a terminal, a wireless communication device, a user agent, or a user equipment. The terminal device in the embodiments of the present disclosure may be a device that provides voice and/or data connectivity to a user, and may be used to connect a person, an object, and a machine, for example, a handheld device or a vehicle-mounted device having a wireless connection function. The terminal device in the embodiments of the present disclosure may be a mobile phone, a pad, a notebook computer, a palmtop computer, a mobile internet device (MID), a wearable device, a virtual reality (VR) device, an augmented reality (AR) device, a wireless terminal in industrial control, a wireless terminal in self-driving, a wireless terminal in a remote medical surgery, a wireless terminal in a smart grid, a wireless terminal in transportation safety, a wireless terminal in a smart city, a wireless terminal in smart home, etc. Optionally, the terminal device may serve as a base station. For example, the terminal device may serve as a scheduling entity that provides a sidelink signal between UEs in vehicle-to-everything (V2X), device-to-device (D2D), or the like. For example, cellular phones and automobiles communicate with each other using sidelink signals. The cellular phone communicates with the smart home device without relaying communication signals through the base station.

The network device in the embodiments of the present disclosure may be a device configured to communicate with the terminal. The network device may also include an access network device. The access network device may also be referred to as a wireless access network device or a base station, etc. The access network device in the embodiments of the present disclosure may refer to a radio access network (RAN) node (or device) that accesses the terminal device to a wireless network. The access network device may broadly cover various names in the following or be replaced with the following names. For example, a node B (NodeB), an evolved NodeB (eNB), a next generation NodeB (gNB), a relay station, an access point, a transmitting and receiving point (TRP), a transmitting point (TP), a master station (MeNB), a secondary station (SeNB), a multi-standard radio (MSR) node, a femtocell, a network controller, an access node, a wireless node, an access point (AP), a transmission node, a transceiver node, a base band unit (BBU), a remote radio unit (RRU), an active antenna unit (AAU), a remote radio unit (RRH), a central unit (CU), a distributed unit (DU), a positioning node, and the like. The base station may be a macro base station, a micro base station, a relay node, a donor node or the like, or a combination thereof. The base station may also refer to a communication module, a modem, or a chip for being disposed in the foregoing device or apparatus. The base station may also be a mobile switching center and a device that plays a role of the base station in the D2D, V2X, and machine-to-machine (M2M) communication, a network side device in a 6G network, and a device that plays a role of the base station in a future communication system, etc. The base station supports networks of the same or different access technologies. The specific technology adopted by the access network device and a specific form of the device in the embodiments of the present disclosure are not limited in the embodiments of the present disclosure.

The base station may be fixed or mobile. For example, a helicopter or drone may be configured to serve as a mobile base station, and one or more cells move according to the position of the mobile base station. In other examples, a helicopter or drone may be configured to serve as a device in communication with another base station.

In some deployments, the network device in the embodiments of the present disclosure may refer to the CU or the DU, or the network device includes the CU and the DU. The gNB may also include the AAU.

The communication devices involved in a wireless communication system may include not only the access network device and the terminal device but also a core network device. The core network device may also be a network device.

The core network device in the embodiments of the present disclosure may include a device that processes and forwards signaling and data for users. For example, the core network device may include a core access and mobility management function (AMF), a session management function (SMF), as well as a user plane gateway, a location server, and other core network devices. Among these, the user plane gateway may be a server having functions such as mobility management, routing, and forwarding of user plane data, typically located on the network side, such as a serving gateway (SGW), a packet data network gateway (PGW), or a user plane function (UPF), etc. The AMF and SMF can be analogous to a mobility management entity (MME) in LTE systems. The AMF is primarily responsible for access control, and the SMF is primarily responsible for session management. Of course, the core network may also include other network elements, which are not listed here.

The network device and the terminal device may be deployed on land, including indoor or outdoor, handheld or vehicle-mounted, may be deployed on a water surface, and may also be deployed on an aircraft, a balloon, and a satellite in the air. A scenario in which the network device and the terminal device are located is not limited in the embodiments of the present disclosure.

It should be understood that all or part of functions of the communication device in the present disclosure may also be implemented by a software function running on hardware or implemented by a virtualization function instantiated on a platform (e.g., a cloud platform).

### Positioning Technology

With increasing maturity of communication technologies, certain communication systems (such as 5G systems) can implement an ever-growing number of communication algorithms. These communication algorithms may include high-speed data transmission, positioning technology, etc. For example, indoor and outdoor positioning and navigation systems, based on satellite navigation technologies represented by BeiDou and supplemented by technologies such as ultra wideband (UWB) and 5G, are profoundly influencing modern lifestyles.

Some wireless communication systems may include servers. Characteristics of servers may include high computational power, large storage capacity, and extremely high throughput efficiency. Therefore, servers can simultaneously perform massive data computations and execute algorithms of higher complexity. Consequently, in related technologies, calculation of location coordinates of the terminal device can be conducted on servers. Therefore, such a server may also be referred to as a location server.

The location server may be a network device with positioning capability provided by an operator. The network device with positioning capability may be the core network device or a cloud server. For example, the location server involved in the embodiments of the present disclosure may include one or more of a location management function (LMF), a location management component (LMC), or a local location management function (LLMF) in the network device, which is not limited in the present disclosure.

The following uses a received signal strength (RSS) positioning algorithm as an example to describe the positioning process. A plurality of network devices (such as access network devices) may be set up in a region to be positioned to send or receive signals. Correspondingly, the terminal device may receive or send signals and record RSS values of each signal. The location server may receive these RSS values. Furthermore, the location server may calculate a position of the terminal device based on the RSS values, positions of the plurality of network devices, and the positioning algorithm.

The above RSS values are related to positioning and may therefore be referred to as positioning data. The positioning data in the present disclosure is not limited to the above RSS values but may also include other data related to positioning. In some cases, the volume of positioning data may be substantial. For example, when a large number of terminal devices connect to a communication network, a massive amount of positioning data may be generated. If the volume of positioning data exceeds an upper limit of a data threshold that the location server can process, it may cause data congestion.

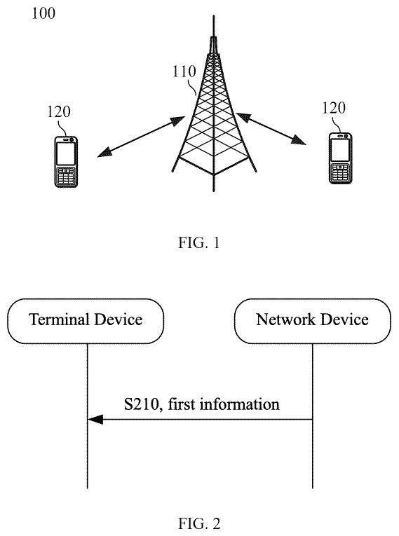

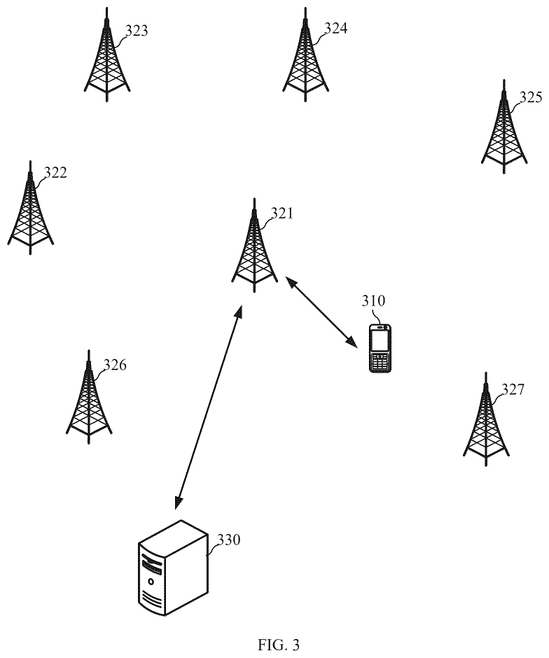

The applicant proposes that information of a first network device may be sent to the terminal device (as shown in operation S210 in FIG. 2) so that the terminal device participates in the position solution, thereby alleviating the pressure on the location server. FIG. 2 is a schematic flowchart of a method for communication provided in the present disclosure. The technical solution provided in the present disclosure is described in detail below with reference to FIG. 2.

FIG. 2 may be implemented by the terminal device and the network device. The network device may be the first network device. The terminal device and the first network device may belong to the communication system, meaning that the present disclosure provides a system implementation scheme based on communication system positioning. This system may adopt an architecture implemented in related technologies. The architecture may include core network devices, access network devices, radio frequency identification units, hubs, field programmable gate arrays (FPGA), etc. Positioning based on the communication system may use positioning methods with multiple access network devices. The terminal device may obtain signal characteristics and other information regarding its position, and the terminal device may resolve its own coordinate information through power information such as signal characteristics. As shown in FIG. 3, access network devices 321 to 327 may send signals to and receive signals from the terminal device, and based on these signals, the terminal device may obtain signal characteristics and other information regarding its position. The location server may achieve the positioning of the terminal device based on the information.

The first network device may include access network devices and/or location servers as described above. For example, the first network device may be any one of the access network devices 321 to 327 in FIG. 3. In the case where the first network device is an access network device, the first network device may also be referred to as a first access network device or a first base station. Alternatively, the first network device may be the location server 330.

The method shown in FIG. 2 may include operation S210. At operation S210, the terminal device receives first information. Correspondingly, the network device sends the first information. The network device may be the first network device.

The first information may be used to indicate information of the first network device. The information of the first network device may be information related to the first network device. Alternatively, the information of the first network device may be information related to the first network device that needs to be used during the position solution of the terminal device.

In some implementations, the first information may be used solely to indicate information of the first network device. For example, when the first information is sent by the first network device, the first information may be used to indicate the first network device's own information. Alternatively, when the first information is sent by a second network device, the first information may be used to indicate information of the first network device that is different from the second network device.

In some implementations, the first information may indicate information of a plurality of network devices. That is, the first information may be used not only to indicate information of the first network device but also to indicate information of other network devices. For example, the first network device may be located in a first region, which may also be referred to as a first site. The first region may include a plurality of network devices. The plurality of network devices in the first region are all able to be used for positioning the terminal device within the first region. The first information may indicate information of all or some of the network devices in the first region.

The present disclosure does not limit the specific content of the information of the first network device. For example, the information of the first network device may include one or more of: an identity of the first network device, an identity of a cell corresponding to the first network device, and position information of the first network device.

Within the first region, the identity of the first network device may be different from identities of other network devices. For example, if the identities of the network devices in the first region are all different, the terminal device may distinguish the first network device from other network devices based on the identities of the network devices.

The first network device may correspond to one or more cells. Alternatively, it can be said that the first network device may configure one or more cells. The identity of the cell may be used to distinguish different cells. Therefore, in some embodiments, the identity of the cell may be represented by a physical cell identity (PCI), which may also be referred to as a physical cell unique identification code. The following will illustrate with an example where the cell corresponding to the first network device includes the first cell. For example, within the first region, the identity of the first cell may be different from the identities of other cells in the first region, allowing the terminal device to distinguish the first cell from other cells in the first region. Alternatively, the identity of the first cell may be different from the identities of other cells corresponding to the first network device. The terminal device may combine the identity of the first network device with the identity of the first cell to distinguish the first cell from other cells.

The position information of the first network device may be used to indicate the position of the first network device. The position of the first network device may be represented in various ways, such as coordinates or latitude and longitude. The present disclosure does not limit the specific representation of the coordinates. For example, coordinates may be represented as (x, y), where x represents an x-axis coordinate and y represents a y-axis coordinate. Alternatively, coordinates may be represented in angular coordinates. For example, coordinates may be represented as (φ, d), where φ represents an angle and d represents a distance. The coordinate system in which the coordinates are may be any geodetic coordinate system or a relative coordinate system. The origin of the relative coordinate system may be the position of the terminal device. Using the relative coordinate system can reduce positioning errors and improve the robustness of the system.

The choice of which coordinate system to use may be determined based on scenarios. That is, the relative coordinate system may be used in a first specific scenario, and/or the geodetic coordinate system may be used in a second specific scenario. The first specific scenario may include an indoor small-scale environment. The second specific scenario may include an outdoor large-scale environment.

Position information may be obtained through a satellite positioning system. The satellite positioning system may include a global positioning system (GPS) and a BeiDou positioning system. The satellite positioning system may encrypt the position information. For example, latitude and longitude information may be encrypted location information from GPS or BeiDou. Alternatively, latitude and longitude information may be unencrypted accurate latitude and longitude position information.

It should be noted that all the plurality of network devices within the first region are able to send the first information to the terminal device. First information sent by different network devices may be the same or different. For example, the first information sent by different network devices may be the same, and the first information may indicate information of all network devices in the first region. Alternatively, the first information sent by different network devices may be different, and the first information may indicate information of a specific network device. The specific network device may be a network device sending the first information.

It should be noted that the network device may send the first information directly to the terminal device, or the network device may send the first information indirectly to the terminal device. For example, the first network device may send the first information to the terminal device indirectly through other communication devices. In some cases, the first information may not be sent by the first network device. For example, in a case where the second network device obtains information of the first network device, the first information may be sent by the second network device. The second network device may be, for example, the location server. The location server may obtain various information from each access network device, and therefore, the first information may be sent by the location server.

For the terminal device, it may obtain the information of the first network device through the first information, so the terminal device may also participate in the positioning process of the terminal device, meaning that the terminal device may participate in position solution. When the terminal device participates in position solution, it may process part of the data, thereby alleviating the pressure on the location server and enhancing the robustness and sustainability of the system.

As an implementation, the terminal device may perform a first operation based on the first information to obtain second information. The first operation may be related to the position solution of the terminal device. That is, the terminal device is able to participate in the position solution through the first operation. Alternatively, the first operation may be part of the position solution. That is, the terminal device is able to undertake part of the work of position solution through the first operation.

The second information may be obtained by the terminal device performing the first operation on the first information. Compared to position information calculated by the location server, the second information may include relatively coarse position information. In other words, the second information may be used to indicate estimated position information of the terminal device. In this case, the first operation may be an estimation operation or a positioning operation.

The second information may include one or both of an estimated distance between the terminal device and the first network device, and a first position solution result of the terminal device.

The estimated distance between the terminal device and the first network device may be estimated by the terminal device. An estimated distance ratio may be derived from the estimated distance. The distance ratio may refer to a ratio of the estimated distance between the terminal device and the first network device to a distance between the terminal device and a reference point.

The first position solution result may be a position estimated by the terminal device. Alternatively, the first position solution result may be an approximate position of the terminal device, i.e., a coarse position. Alternatively, the first position solution result may be a preliminary calculated position of the terminal device, i.e., a preliminary position. Since the computational capability of the terminal device is far lower than that of the location server, the accuracy of the first position solution result is usually lower. In some embodiments, the first position solution result does not meet positioning accuracy requirements of communication standards. Therefore, in some embodiments, the first position solution result may also be referred to as the coarse position or approximate position of the terminal device.

In some implementations, the first position solution result may be achieved based on algorithms with less computation. Algorithms with less computation may yield the first position solution result with fewer iterations (e.g., one iteration). For example, the first position solution result may be determined based on a Lagrange operator product algorithm. The Lagrange operator product algorithm is a positioning algorithm with relatively low computational complexity. Due to the limited computational power of the terminal device, using such a low-complexity positioning algorithm can reduce the computational burden on the terminal device, decrease computation time, and improve the computational efficiency of the terminal device, thereby meeting the requirements for real-time positioning.

The second information may be related to a position of a master network device in the first region. As mentioned above, the first region may include a plurality of network devices. The plurality of network devices may include one master network device. In the first region, network devices other than the master network device may be referred to as neighbor network devices. For example, the first region may include 1+N network devices, where N is greater than 1. The 1+N network devices may include one master network device and N neighbor network devices. Taking N as 6 as an example, the first region may include 7 network devices, one of which is the master network device and six of which are neighbor network devices.

It should be noted that the master network device and neighbor network devices may have different functions. As an implementation, the master network device may serve as the reference point in the positioning algorithm. For example, the master network device may be a reference point in a difference of received signal strength (DRSS) algorithm. In related technologies (such as DRSS or RSS algorithms), a position of a reference point or a reference base station is needed as a reference position for positioning. For example, a point x meters away from a certain base station may be selected as the reference point, or the base station may be used as the reference base station. However, in practical positioning environments, collecting reference points at each base station involves a significant workload, so the present disclosure proposes the master network device to simplify the reference point collection process.

It should be noted that when the network device is the base station, the master network device may also be referred to as the master base station, and the neighbor network devices may be referred to as neighbor base stations.

The following will provide a detailed description of determining the first position solution result based on the position of the master network device and the Lagrange operator product algorithm.

As a possible implementation, the first position solution result \hat{∈} may be calculated using the following formula. That is, the first position solution result \hat{∈} may satisfy the formula:

$$\begin{matrix}A = [ \begin{matrix}{x}_{1} - {x}_{0} {\hat{\partial }}_{1}^{2} & {y}_{1} - {y}_{0} {\hat{\partial }}_{1}^{2} & {\hat{\partial }}_{1} - 1 \\ … & … & … \\ {x}_{m} - {x}_{0} {\hat{\partial }}_{m}^{2} & {y}_{m} - {y}_{0} {\hat{\partial }}_{m}^{2} & {\hat{\partial }}_{m} - 1\end{matrix} ] , B = [ \begin{matrix}{x}_{1}^{2} + {y}_{1}^{2} - ( {x}_{0}^{2} + {y}_{0}^{2} ) {\hat{\partial }}_{1}^{2} \\ … \\ {x}_{m}^{2} + {y}_{m}^{2} - ( {x}_{0}^{2} + {y}_{0}^{2} ) {\hat{\partial }}_{m}^{2}\end{matrix} ] , \\ \hat{ϵ} = {( {A}^{T} A )}^{- 1} {A}^{T} B .\end{matrix}$$

where (x₀, y₀) are position coordinates of the master network device, (x₁, y₁) to (xₘ, yₘ) are position coordinates of a first neighbor network device to an m^{th} neighbor network device, respectively, \hat{∂}ₘ is an estimated distance ratio between the terminal device and the m^{th} neighbor network device. As a Lagrange operator product algorithm, in the above formula provided in the present disclosure, A may be a result matrix, and B may be an error matrix.

The second information may further include other positioning-related information. For example, the second information may further include various measurement data required by the positioning algorithm held by the location server.

After obtaining the second information, the terminal device may send the second information to the first network device. For example, the terminal device may send the second information to a first access network device. Alternatively, the terminal device may send the second information to the location server. As an implementation, the terminal device may send the second information to the master base station, and then the first network device may send the second information to the location server. In other words, the terminal device may send the second information to the location server through the first network device. In some embodiments, the first network device may be the master network device.

It should be noted that before the location server receives the second information, other communication devices transmitting the second information may process the second information. Taking the case where the terminal device sends the second information to the location server through the first network device as an example, the first network device may process the second information and send the processed second information to the location server. This processing may be, for example, part of the positioning solution process. That is, even when the first network device is not the location server, the first network device may still participate in the positioning solution of the terminal device. It should be understood that processing the second information by other communication devices transmitting the second information improves the transmission efficiency of the second information and reduces the computational burden on the location server.

After receiving the second information, the location server may perform the positioning solution for the terminal device based on the second information, thereby obtaining more accurate positioning information. The location server may use an algorithm with higher computational complexity to process the second information. The algorithm used by the location server may include a maximum a posteriori (MAP) or maximum likelihood (ML) algorithm. In some embodiments, a data transmission time may be determined to achieve real-time positioning for the terminal device, and techniques such as time of arrival (TOA) and time difference of arrival (TDOA) may be utilized for auxiliary positioning. After obtaining accurate positioning information, the location server may return the accurate positioning information to the terminal device.

Based on the present disclosure, the allocation of computation is achieved during the positioning solution of the terminal device, meaning that the solution tasks may be allocated to different communication devices for processing, thereby achieving a faster positioning result solution and meeting the requirements for real-time positioning.

As mentioned above, the first region may include the master network device and neighbor network devices. In some embodiments, the master network device and/or neighbor network devices may be fixed or determined. For example, regardless of the position of the terminal device within the first region, all the master network device and neighbor network devices do not change. In some embodiments, the master network device and neighbor network devices may be variable. For example, when the terminal device is at a first point, the master network device may be the first network device; and when the terminal device is at a second point, the master network device may be another network device other than the first network device.

The present disclosure does not limit the method for determining the master network device and neighbor network devices. For example, the master network device and neighbor network devices may be pre-configured or preset values. In this case, the master network device and neighbor network devices may be fixed or determined. Alternatively, the master network device and neighbor network devices may be determined based on the situation of the terminal device. In this case, the master network device and neighbor network devices may be either fixed or variable. As an implementation, when the terminal device enters the first region, the master network device and/or neighbor network devices may be determined based on the situation of the terminal device, and once determined, the master network device will not change until the terminal device leaves the first region. As another implementation, when the terminal device is within the first region, the master network device and/or neighbor network devices may be dynamically changed or adjusted based on state changes of the terminal device.

As an implementation, the plurality of network devices may include a second network device. When a first condition is met, the second network device may serve as the master network device. The first condition, for example, may relate to one or both of: a quality of a signal transmitted by the second network device, and a position relationship between the second network device and the terminal device.

The quality of the signal transmitted by the second network device may be represented by one or more of the following indicators: reference signal received power (RSRP), reference signal received quality (RSRQ), and received signal strength indicator (RSSI). In some embodiments, the quality of the signal may be represented by one or more of the following indicators: synchronization signal-reference signal received power (SS-RSRP), synchronization signal-reference signal received quality (SS-RSRQ), synchronization signal-received signal strength indicator (SS-RSSI).

The first condition may include that the quality of the signal transmitted by the second network device meets certain conditions. For example, among the plurality of network devices in the first region, if the quality of the signal transmitted by the second network device is the best (e.g., maximum RSRP), the second network device may be the master network device. In this case, if the master network device is set as a reference point, the first condition related to the quality of the signal may result in the distance ratio greater than 1. For the DRSS algorithm, when the distance ratio is greater than 1, the DRSS calculated through log may have practical physical significance, otherwise, the DRSS calculated through log may be less than 0 and does not have practical physical significance.

The position relationship between the second network device and the terminal device may include one or more of: a distance, an angle, etc., between the second network device and the terminal device. Taking distance as an example, the first condition may include that the distance between the second network device and the terminal device meets certain conditions. For example, among the plurality of network devices, the distance between the second network device and the terminal device is the minimum.

It should be understood that the quality of the signal may also reflect the distance between the second network device and the terminal device to some extent. That is, the better the signal quality, the closer the distance; and the poorer the signal quality, the farther the distance. Other indicators that reflect the distance between the second network device and the terminal device may also be related to the first condition. The first condition corresponding to these indicators corresponds to the first condition related to distance.

In the process of positioning the terminal device, a position of the network device affects the accuracy of the terminal device's positioning. To address this, the present disclosure proposes that when a second condition is met, the network device may be used for positioning the terminal device. The second condition may be related to the position of the network device.

Based on the second condition, suitable network device(s) for positioning the terminal device may be preferentially selected. That is, when the second condition is met, the positioning of the terminal device may achieve better positioning performance. For example, one or more network devices suitable for positioning the terminal device may be preferentially selected around the terminal device. In other words, it is not necessary to use all the network devices around the terminal device (e.g., all network devices within the first region) for positioning the terminal device, but rather to use the network devices that satisfy the second condition for positioning. When the network device moves, is placed, or installed in a position that satisfies the second condition, the network device is used for positioning the terminal device. Therefore, the second condition provided in the present disclosure may also be understood as a condition for improving the placement or installation of network devices.

Based on the second condition provided in the present disclosure, network devices that are more suitable for positioning the terminal device may be selected. Alternatively, in other words, network devices that reduce positioning performance and accuracy may be eliminated based on the present disclosure, thereby achieving more accurate positioning.

In some embodiments, the plurality of network devices in the first region may include the master network device and m neighbor network devices, where m may be a positive integer. It should be noted that the master network device and m neighbor network devices may be all network devices within the first region or part of the network devices within the first region. When the second condition is met, the master network device and/or m neighbor network devices may be used for positioning the terminal device. When the second condition is not met, the master network device and/or m neighbor network devices may not be used for positioning the terminal device. The second condition may relate to one or more of the following information regarding the master network device and/or m neighbor network devices: a quality of a transmitted signal, a position relationship with the terminal device, and horizontal dilution of precision (HDOP).

The transmitted signal may be the signal received and/or sent by the network device. This signal may be a signal used for positioning. For example, the signal may include a synchronization signal (SS). The quality of the signal may be indicated by one or more of the following indicators: RSRP, RSRQ, RSSI, difference of reference signal received power (DRSRP), difference of reference signal received quality (DRSRQ), difference of received signal strength indicator (DRSSI), etc. In some embodiments, the quality of the signal may be represented by one or more of the following indicators: SS-RSRP, SS-RSRQ, SS-RSSI.

In the case where the second condition is related to the quality of the signal, the second condition may include that the quality of the signal is greater than or equal to a first quality threshold and/or the quality of the signal is less than or equal to a second quality threshold. On the one hand, the network device may only be used for positioning the terminal device when the quality of the signal transmitted by the network device is relatively high. On the other hand, when the quality of the signal transmitted by the network device is excessively high, the terminal device may be directly below the network device, which may lead to abnormal positioning. Therefore, the quality of the signal may be less than or equal to the second quality threshold. For example, if the Lagrange operator product algorithm is used for positioning solution, when the terminal device is directly below the network device, the result matrix in the Lagrange operator product may become a singular matrix, so that the result matrix cannot be inverted, resulting in failure to calculate the positioning result.

The present disclosure does not limit specific values of the first quality threshold and the second quality threshold, which may be obtained through experiments or simulations. For example, the first quality threshold may be −110 dBm. The second quality threshold may be −40 dBm.

The position relationship between the network device and the terminal device may include the distance, coverage area, relative angular relationship, etc. Taking distance as an example, when the second condition is related to the distance between the network device and the terminal device, the second condition may include that the distance is less than or equal to a distance threshold. In other words, the network device may only be used for positioning the terminal device when it is relatively close to the terminal device.

In satellite navigation systems, a smaller HDOP indicates higher positioning accuracy. The applicant introduces HDOP into communication system positioning (e.g., 5G positioning) to analyze positioning trajectories. In comparison to satellite navigation systems, the terminal device may be analogous to a receiver in a satellite navigation system, and the network device may be analogous to an observable satellite in the satellite navigation system. Therefore, HDOP may be used to indicate the coverage situation of the network devices over the terminal device.

As an implementation, HDOP may satisfy the following formula:

$$H = [ \begin{matrix}\frac{\hat{x} - {x}_{0}}{{\hat{d}}_{0}} & \frac{\hat{y} - {y}_{0}}{{\hat{d}}_{0}} \\ ⋮ & ⋮ \\ \frac{\hat{x} - {x}_{m}}{{\hat{d}}_{m}} & \frac{\hat{y} - {y}_{m}}{{\hat{d}}_{m}}\end{matrix} ] , G = {( {H}^{T} H )}^{- 1} , HDOP = {G}_{11} + {G}_{22} ;$$

where (x₀, y₀) are position coordinates of the master network device, (x₁, y₁) to (xₘ, yₘ) are coordinates of a first neighbor network device to an m^{th} neighbor network device, respectively, (\hat{x}, ŷ) are coordinates of the terminal device, \hat{d}₀ is a distance between the terminal device and the master network device, \hat{d}₁ to \hat{d}ₘ are distances between the terminal device and the first neighbor network device to the m^{th} neighbor network device, respectively.

In the case where the second condition is related to HDOP, the second condition may include that HDOP is less than or equal to a first accuracy threshold. In other words, the network device may only be used for positioning the terminal device when HDOP is relatively small. When the coverage area of the network device cannot cover the terminal device, HDOP may be large. Therefore, the present disclosure sets the second condition to be that the HDOP is small so that the coverage area of the network device is able to cover the terminal device, thereby ensuring that the positioning accuracy meets the requirements and achieving better positioning performance.

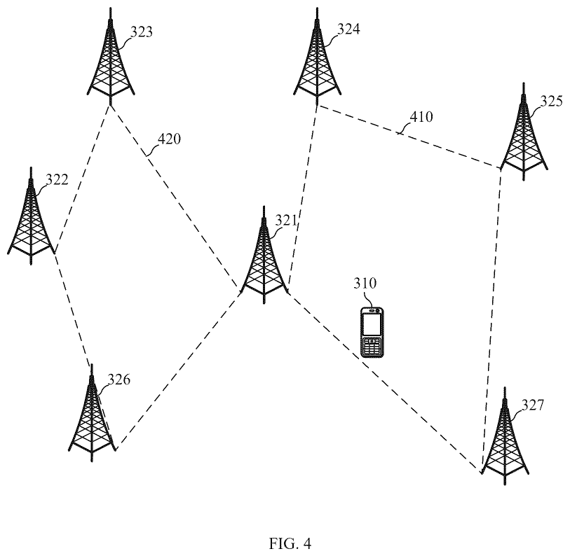

In some embodiments, the second condition includes that the coverage areas of the master network device and m neighbor network devices are all able to cover the terminal device. That is, the terminal device cannot be in a region covered by only one base station. The network device may correspond to one or more cells, within which the terminal device may communicate with the first network device. In other words, the region covered by one or more cells may be the region covered by corresponding network devices. The positions of the master network device and m neighbor network devices may form a geometry. If this geometry includes the terminal device (i.e., the terminal device is inside the geometry), it may be considered that the coverage areas of the master network device and m neighbor network devices are all able to cover the terminal device. In other words, when positioning the terminal device, it is preferable to avoid being too close to the base station and to avoid moving outside the region of the geometry. As shown in FIG. 4, geometry 410 covers the terminal device 310. Therefore, network devices 321, 324, 325, and 327 that form the geometry 410 may be selected for positioning the terminal device. Geometry 420 cannot cover the terminal device 310. Therefore, network devices 321, 322, 323, and 326 that form the geometry 420 cannot be selected and thus cannot be used for positioning the terminal device.

Additionally, when the terminal device is located at the center of the geometry, the positioning accuracy is higher. Based on this, the second condition may include that the geometry is a relatively regular geometry; and/or a distance between the terminal device and the center of the geometry is less than or equal to a distance threshold.

It should be noted that the network devices involved in the present disclosure, such as the first network device or the second network device, may both be existing network devices (e.g., 5G base stations and/or 5G-A base stations) in the relevant communication system. Therefore, in the relevant communication system, there is no need for additional hardware upgrades or installations to implement the present disclosure. Moreover, the present disclosure does not limit the hardware composition of the communication system applying the present disclosure. For example, in a 5G-A positioning system, some hardware may be added to enhance its performance, making it easy to promote. For another example, the present disclosure may also be applied in outdoor positioning scenarios with complex environments and various LOS/NLOS environments. Therefore, the present disclosure has significant advantages and commercial prospects.

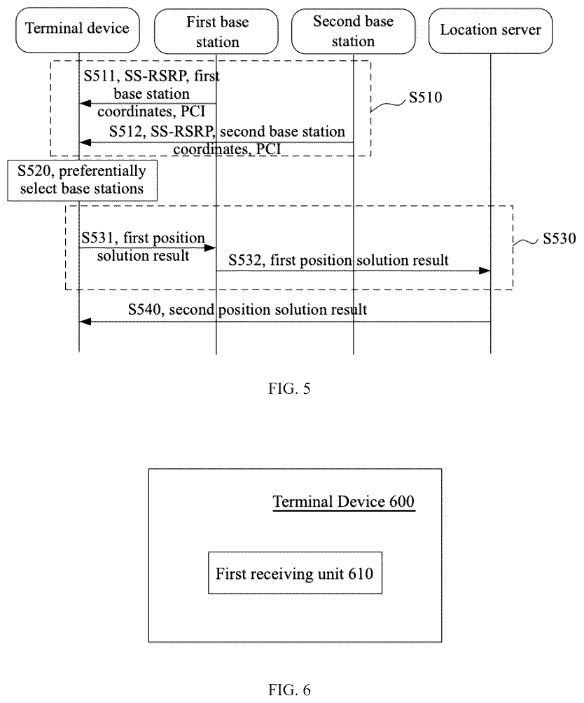

To facilitate the understanding of the present disclosure, the following provides a detailed description of the embodiments provided in the present disclosure in conjunction with FIG. 5. The method shown in FIG. 5 may be performed by the terminal device, master base station, neighbor base stations, and location server. The method illustrated in FIG. 5 includes operations S510 to S540.

At operation S510, the terminal device collects data. Operation S510 may include operations S511 and S512.

At operation S511, a first base station sends one or more of SS-RSRP, coordinates of the first base station, PCI, etc., to the terminal device.

At operation S512, a second base station sends one or more of SS-RSRP, coordinates of the second base station, PCI, etc., to the terminal device.

At operation S520, the terminal device preferentially selects base stations suitable for positioning. This involves setting the placement positions of the base stations, which need to be deployed according to a relatively regular geometry. Additionally, the terminal device cannot be located too close to the base stations during positioning, nor can it move outside the geometry formed by the respective base stations. That is, the terminal device cannot be in a region in which base stations are located in only one coverage direction. Meanwhile, any base station that results in a high HDOP should be excluded. Furthermore, the prerequisite for excluding a base station is that at least four base stations should be observable from a source point. Meanwhile, SS-RSRP needs to be selected. If SS-RSRP is less than −110 dBm, it indicates that the data is invalid, as the data would lead to a decrease in the final positioning accuracy. All base stations may be placed under the same site. Alternatively, in large-scale environments such as outdoors, all base stations may be divided into multiple sites, with each site including three base stations. Meanwhile, the terminal device should be allowed to move within the maximum coverage area of the base stations and should not exceed a designated range. It should be noted that operation S520 may be executed in advance in a designated testing environment, meaning that operation S520 may be implemented prior to operation S510.

At operation S530, data preprocessing and calculation of subsequent relevant results are performed in the mobile terminal, and results are sent to the location server.

Operation S530 may include operations S531 and S532.

At operation S531, the terminal device sends preliminary results (including the first position solution result) obtained by the mobile terminal back to the master base station. FIG. 5 illustrates with the first base station being the master base station as an example.

At operation S532, the master base station transmits this result (including the first position solution result) to the location server.

At operation S540, the location server performs the final coordinate solution and sends the obtained result back to the master base station, and the master base station then delivers the result to the terminal device.

The method embodiments of the present disclosure are described in detail above, and the apparatus embodiments of the present disclosure are described in detail below. It should be understood that descriptions of the method embodiments correspond to descriptions of the apparatus embodiments, and therefore, reference may be made to the foregoing method embodiments for parts that are not described in detail.

FIG. 6 is a schematic structural diagram of a terminal device 600 provided in an embodiment of the present disclosure. The terminal device 600 may include a first receiving unit 610.

The first receiving unit 610 is configured to receive first information, where the first information is used to indicate information of the first network device, and the first information is related to positioning of the terminal device.

In some embodiments, the information of the first network device includes one or more of: an identity of the first network device; an identity of a cell corresponding to the first network device; and position information of the first network device.

In some embodiments, the terminal device further includes: an execution unit, configured to execute a first operation based on the first information to obtain second information; where the first operation is related to a position solution of the terminal device.

In some embodiments, the second information includes one or both of: an estimated distance between the terminal device and the first network device; and a first position solution result of the terminal device.

In some embodiments, the terminal device further includes: a first sending unit, configured to send the second information; where the second information is used to determine a second position solution result of the terminal device.

In some embodiments, the first network device is located in a first region, the first region includes a plurality of network devices, the plurality of network devices include a master network device, and the second information is related to a position of the master network device.

In some embodiments, the second information includes the first position solution result of the terminal device, and the first position solution result is determined based on a Lagrange operator product algorithm and the position of the master network device.

In some embodiments, the plurality of network devices include a second network device, the second network device is the master network device when a first condition is met, and the first condition is related to one or both of: a quality of a signal transmitted by the second network device; and a position relationship between the second network device and the terminal device.

In some embodiments, the first condition includes: a distance between the second network device and the terminal device is minimum in the plurality of network devices; and/or, the quality of the signal transmitted by the second network device is best in the plurality of network devices.

In some embodiments, the plurality of network devices further include m neighbor network devices, m is a positive integer, and one or both of the master network device and the m neighbor network devices are configured to position the terminal device when a second condition is met; and where the second condition is related to one or both of following information of one or both of the master network device and the m neighbor network devices: a quality of a transmitted signal; a position relationship with the terminal device; and horizontal dilution of precision (HDOP).

In some embodiments, the HDOP satisfies:

$$H = [ \begin{matrix}\frac{\hat{x} - {x}_{0}}{{\hat{d}}_{0}} & \frac{\hat{y} - {y}_{0}}{{\hat{d}}_{0}} \\ ⋮ & ⋮ \\ \frac{\hat{x} - {x}_{m}}{{\hat{d}}_{m}} & \frac{\hat{y} - {y}_{m}}{{\hat{d}}_{m}}\end{matrix} ] , G = {( {H}^{T} H )}^{- 1} , HDOP = {G}_{11} + {G}_{22} ;$$

where (x₀, y₀) are position coordinates of the master network device, (x₁, y₁) to (xₘ, yₘ) are coordinates of a first neighbor network device to an m^{th} neighbor network device, respectively, (\hat{x}, ŷ) are coordinates of the terminal device, \hat{d}₀ is a distance between the terminal device and the master network device, \hat{d}₁ to \hat{d}ₘ are distances between the terminal device and the first neighbor network device to the m^{th} neighbor network device, respectively, and G₁₁ and G₂₂ are diagonal elements of G.

In some embodiments, the second condition includes that coverage areas of the master network device and the m neighbor network devices are all able to cover the terminal device.

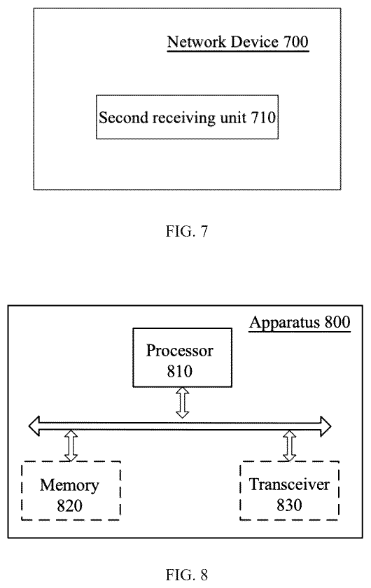

FIG. 7 is a schematic structural diagram of a network device 700 according to an embodiment of the present disclosure. The network device 700 may be a first network device, and the network device 700 may include a second sending unit 710.

The second sending unit 710 is configured to send first information to the terminal device, where the first information is used to indicate information of the first network device, and the first information is related to positioning of the terminal device.

In some embodiments, the information of the first network device includes one or more of: an identity of the first network device; an identity of a cell corresponding to the first network device; and position information of the first network device.

In some embodiments, the network device further includes: a second receiving unit, configured to receive second information sent by the terminal device; where the second information is obtained based on the first information and a first operation, and the first operation is related to a position solution of the terminal device.

In some embodiments, the second information includes one or both of: an estimated distance between the terminal device and the first network device; and a first position solution result of the terminal device.

In some embodiments, the network device further includes: a determining unit, configured to determine a second position solution result of the terminal device according to the second information.

In some embodiments, the first network device is located in a first region, the first region includes a plurality of network devices, the plurality of network devices include a master network device, and the second information is related to a position of the master network device.

In some embodiments, the second information includes the first position solution result of the terminal device, and the first position solution result is determined based on a Lagrange operator product algorithm and the position of the master network device.

In some embodiments, the plurality of network devices include a second network device, the second network device is the master network device when a first condition is met, and the first condition is related to one or both of: a quality of a signal transmitted by the second network device; and a position relationship between the second network device and the terminal device.

In some embodiments, the first condition includes: a distance between the second network device and the terminal device is minimum in the plurality of network devices; and/or, the quality of the signal transmitted by the second network device is best in the plurality of network devices.

In some embodiments, the plurality of network devices further include m neighbor network devices, m is a positive integer, and one or both of the master network device and the m neighbor network devices are configured to position the terminal device when a second condition is met; and where the second condition is related to one or more of following information of one or both of the master network device and the m neighbor network devices: a quality of a transmitted signal; a position relationship with the terminal device; and horizontal dilution of precision (HDOP).

In some embodiments, the HDOP satisfies:

$$H = [ \begin{matrix}\frac{\hat{x} - {x}_{0}}{{\hat{d}}_{0}} & \frac{\hat{y} - {y}_{0}}{{\hat{d}}_{0}} \\ ⋮ & ⋮ \\ \frac{\hat{x} - {x}_{m}}{{\hat{d}}_{m}} & \frac{\hat{y} - {y}_{m}}{{\hat{d}}_{m}}\end{matrix} ] , G = {( {H}^{T} H )}^{- 1} , HDOP = {G}_{11} + {G}_{22} ;$$

where (x₀, y₀) are position coordinates of the master network device, (x₁, y₁) to (xₘ, yₘ) are coordinates of a first neighbor network device to an m^{th} neighbor network device, respectively, (\hat{x}, ŷ) are coordinates of the terminal device, \hat{d}₀ is a distance between the terminal device and the master network device, \hat{d}₁ to \hat{d}ₘ are distances between the terminal device and the first neighbor network device to the m^{th} neighbor network device, respectively, and G₁₁ and G₂₂ are diagonal elements of G.

In some embodiments, the second condition includes that coverage areas of the master network device and the m neighbor network devices are all able to cover the terminal device.

In an optional embodiment, the first receiving unit 610 or the second receiving unit 710 may be a transceiver 830. The terminal device 600 or the network device 700 may further include a memory 820 and/or a processor 810, as shown in FIG. 8.

FIG. 8 is a schematic structural diagram of an apparatus for communication according to an embodiment of the present disclosure. The dashed line in FIG. 8 indicates that the unit or module is optional. The apparatus 800 may be configured to implement the method described in the foregoing method embodiments. The apparatus 800 may be one or more of a chip, a terminal device, or a network device.

The apparatus 800 may include one or more processors 810, and the processor 810 may support the apparatus 800 to implement the method described in the foregoing method embodiments. The processor 810 may be a general-purpose processor or a dedicated processor. For example, the processor may be a central processing unit (CPU). Alternatively, the processor may be another general-purpose processor, a digital signal processor (DSP), an application specific integrated circuit (ASIC), a field programmable gate array (FPGA) or other programmable logic devices, a discrete gate or transistor logic device, a discrete hardware component, or the like. The general-purpose processor may be a microprocessor, or the processor may be any conventional processor or the like.

The apparatus 800 may further include one or more memories 820 storing a program, and the program may be executed by the processor 810 to cause the processor 810 to perform the method described in the foregoing method embodiments. The memory 820 may be independent of the processor 810 or may be integrated into the processor 810.

The apparatus 800 may further include a transceiver 830, and the processor 810 may communicate with another device or chip via the transceiver 830. For example, the processor 810 may perform data transceiving with another device or chip via the transceiver 830.

Embodiments of the present disclosure further provide a computer-readable storage medium, configured to store a program. The computer-readable storage medium may be applied to the terminal or network device provided in the embodiments of the present disclosure, and the program causes the computer to perform the method performed by the terminal or network device in the embodiments of the present disclosure.

Embodiments of the present disclosure further provide a computer program product. The computer program product includes a program. The computer program product may be applied to the terminal or network device provided in the embodiments of the present disclosure, and the program causes the computer to perform the method performed by the terminal or network device in the embodiments of the present disclosure.

Embodiments of the present disclosure further provide a computer program. The computer program may be applied to the terminal or network device provided in the embodiments of the present disclosure, and the computer program causes the computer to perform the method performed by the terminal or network device in the embodiments of the present disclosure.

It should be understood that the terms “system” and “network” may be used interchangeably in the present disclosure. In addition, the terms used in the present disclosure are intended only to explain specific embodiments of the present disclosure and are not intended to limit the present disclosure. The terms “first”, “second”, “third” and “fourth” in the description and claims as well as the accompanying drawings of the present disclosure are used to distinguish between different objects and not to describe a particular order. Furthermore, the terms “including” and “having”, and any variation thereof, are intended to cover non-exclusive inclusion.

In the embodiments of the present disclosure, the term “indication” mentioned in the embodiments of the present disclosure may be a direct indication, or may be an indirect indication, or may indicate that there is an association relationship. For example, A indicates B, which may indicate that A directly indicates B, e.g., B is obtained through A, or may indicate that A indirectly indicates B, e.g., A indicates C and B is obtained through C, or may indicate that A and B have an association relationship.

In the embodiments of the present disclosure, “B corresponding to A” indicates that B is associated with A, and B may be determined based on A. However, it should be further understood that, determining B based on A does not mean that B is determined only based on A, or B may also be determined based on A and/or other information.

In the embodiments of the present disclosure, the term “corresponding” in the embodiments of the present disclosure may indicate that there is a direct correspondence or indirect correspondence between the two, or may indicate that there is an association relationship between the two, or may be relationships such as indicating and being indicated, configuring and being configured, etc.

In the embodiments of the present disclosure, the terms “predefined” and “preconfigured” may be implemented by pre-storing a corresponding code, a table, or another manner that can be used to indicate related information in a device (e.g., a terminal device and a network device), and a specific implementation is not limited in the present disclosure. For example, the predefined may indicate being defined in a protocol.

In the embodiments of the present disclosure, the term “protocol” in the embodiments of the present disclosure may refer to a standard protocol in the field of communications, such as an LTE protocol, an NR protocol, and related protocols applied to a future communications system, which is not limited in the present disclosure.

In the embodiments of the present disclosure, the term “and/or” in this specification is merely an association relationship for describing associated objects, indicating that there are three relationships, e.g., A and/or B may indicate that A exists alone, A and B exist at the same time, and B exists alone. In addition, the character “/” in this specification generally indicates an “or” relationship between the associated objects.

In embodiments of the present disclosure, “including” may indicate either directly or indirectly including. Optionally, references to “including” in embodiments of the present disclosure may be replaced with “indicating” or “used to determine”. For example, A including B may be replaced with A indicating B or A used to determine B.

In the embodiments of the present disclosure, in various embodiments of the present disclosure, a size of a sequence number of each process does not mean an execution sequence, and the execution sequence of each process should be determined by its function and internal logic but should not constitute any limitation on an implementation process of the embodiments of the present disclosure.

In the several embodiments provided in the present disclosure, it should be understood that the disclosed system, apparatus, and method may be implemented in other manners. For example, the apparatus embodiments described above are merely illustrative, and the division of the units is merely a logical function division. In actual implementation, there may be alternative division manners, such as combining a plurality of units or components or integrating them into another system, or ignoring or not executing some features. In addition, the shown or discussed mutual coupling or direct coupling or communication connection may be indirect coupling or communication connection through some interfaces, devices, or units, which may be electrical, mechanical, or in other forms.

The units described as separate parts may or may not be physically separate, and parts shown as units may or may not be physical units, i.e., may be located in one position, or may be distributed on a plurality of network units. Some or all of the units may be selected according to actual needs to achieve the objectives of the solutions of the embodiments.

In addition, functional units in the embodiments of the present disclosure may be integrated into one processing unit, or each of the units may exist alone physically, or two or more units are integrated into one unit.

All or some of the foregoing embodiments may be implemented by using software, hardware, firmware, or any combination thereof. When software is used to implement the embodiments, all or some of the embodiments may be implemented in a form of a computer program product. The computer program product includes one or more computer instructions. When the computer program instructions are loaded and executed on a computer, the procedures or functions according to the embodiments of the present disclosure are all or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium, for example, the computer instructions may be transmitted from a website, a computer, a server, or a data center to another website, computer, server, or data center in a wired (e.g., a coaxial cable, an optical fiber, a digital subscriber line (DSL)) or a wireless (e.g., infrared, wireless, microwave, etc.) manner. The computer-readable storage medium may be any usable medium readable by a computer, or a data storage device, such as a server or a data center including one or more integrated usable media. The usable medium may be a magnetic medium (e.g., a floppy disk, a hard disk, or a magnetic tape), an optical medium (e.g., a digital video disk (DVD)), a semiconductor medium (e.g., a solid state disk (SSD)), or the like.

The foregoing descriptions are merely specific implementations of the present disclosure, but the protection scope of the present disclosure is not limited thereto, and any changes or substitutions may be easily conceived of by a person skilled in the art within the technical scope disclosed in the present disclosure. Therefore, the protection scope of the present disclosure shall be subject to the protection scope of the claims.

What is claimed is:

1. A method for communication, comprising:
receiving, by a terminal device, first information, wherein the first information indicates information of a first network device, and the first information is related to positioning of the terminal device; and
performing, based on the first information, a first operation related to a position solution of the terminal device.

2. The method according to claim 1, wherein the information of the first network device includes one or more of:
an identity of the first network device;
an identity of a cell corresponding to the first network device; or
position information of the first network device.

3. The method according to claim 1, wherein performing the first operation comprise:
executing, by the terminal device, the first operation based on the first information to obtain second information.

4. The method according to claim 3, wherein the second information includes at least one of:
an estimated distance between the terminal device and the first network device; or
a first position solution result of the terminal device.

5. The method according to claim 3, further comprising:
sending, by the terminal device, the second information;
wherein the second information is used to determine a second position solution result of the terminal device.

6. The method according to claim 3, wherein the first network device is located in a first region, the first region includes a plurality of network devices, the plurality of network devices include a master network device, and the second information is related to a position of the master network device.

7. The method according to claim 6, wherein the second information includes a first position solution result of the terminal device, and the first position solution result is determined based on a Lagrange operator product algorithm and the position of the master network device.

8. The method according to claim 6, wherein the plurality of network devices include a second network device, the second network device is the master network device when a first condition is met, and the first condition is related to at least one of:
a quality of a signal transmitted by the second network device; or
a position relationship between the second network device and the terminal device.

9. The method according to claim 8, wherein the first condition includes at least one of:
a distance between the second network device and the terminal device is minimum in the plurality of network devices; or,
the quality of the signal transmitted by the second network device is best in the plurality of network devices.

10. The method according to claim 6, wherein the plurality of network devices further include m neighbor network devices, m is a positive integer, and at least one of the master network device or the m neighbor network devices are configured to position the terminal device when a second condition is met; and wherein the second condition is related to at least one of following information of the at least one of the master network device or the m neighbor network devices:
a quality of a transmitted signal;
a position relationship with the terminal device; or
horizontal dilution of precision (HDOP).

11. The method according to claim 10, wherein the HDOP satisfies:
$$H = [ \begin{matrix}\frac{\hat{x} - {x}_{0}}{{\hat{d}}_{0}} & \frac{\hat{y} - {y}_{0}}{{\hat{d}}_{0}} \\ ⋮ & ⋮ \\ \frac{\hat{x} - {x}_{m}}{{\hat{d}}_{m}} & \frac{\hat{y} - {y}_{m}}{{\hat{d}}_{m}}\end{matrix} ] , G = {( {H}^{T} H )}^{- 1} , HDOP = {G}_{11} + {G}_{22} ;$$
wherein (x₀, y₀) are position coordinates of the master network device, (x₁, y₁) to (xₘ, yₘ) are coordinates of a first neighbor network device to an m^{th} neighbor network device, respectively, (\hat{x}, ŷ) are coordinates of the terminal device, \hat{d}₀ is a distance between the terminal device and the master network device, \hat{d}₁ to \hat{d}ₘ are distances between the terminal device and the first neighbor network device to the m^{th} neighbor network device, respectively, and G₁₁ and G₂₂ are diagonal elements of G.

12. The method according to claim 10, wherein the second condition includes that coverage areas of the master network device and the m neighbor network devices are all able to cover the terminal device.

13. A method for communication, comprising:
sending, by a first network device, first information to a terminal device;
wherein the first information indicates information of the first network device, and the first information is related to positioning of the terminal device.

14. The method according to claim 13, wherein the information of the first network device includes one or more of:
an identity of the first network device;
an identity of a cell corresponding to the first network device; or
position information of the first network device.

15. The method according to claim 13, further comprising:
receiving, by the first network device, second information sent by the terminal device;
wherein the second information is obtained based on the first information and a first operation, and the first operation is related to a position solution of the terminal device.

16. The method according to claim 15, wherein the second information includes at least one of:
an estimated distance between the terminal device and the first network device; or
a first position solution result of the terminal device.

17. The method according to claim 15, further comprising:
determining, by the first network device, a second position solution result of the terminal device according to the second information.

18. The method according to claim 15, wherein the first network device is located in a first region, the first region includes a plurality of network devices, the plurality of network devices include a master network device, and the second information is related to a position of the master network device.

19. The method according to claim 18, wherein the second information includes a first position solution result of the terminal device, and the first position solution result is determined based on a Lagrange operator product algorithm and the position of the master network device.

20. An apparatus, comprising:
at least one processor; and
one or more non-transitory computer-readable storage media coupled to the at least one processor and storing programming instructions for execution by the at least one processor, wherein the programming instructions, when executed, cause the apparatus to perform operations comprising:
receiving first information, wherein the first information indicates information of a first network device, and the first information is related to positioning of a terminal device.
